(19) United States
(12) Patent Application Publication
(10) Pub. No.: US 2023/0139483 A1
(43) Pub. Date: May 4, 2023

(54) METHOD FOR VIBRATION ENHANCED ALVEOLAR AUGMENTATION

(71) Applicant: PerioTech, LLC, Palm Beach Gardens, FL (US)

(72) Inventors: Robert A. HOROWITZ, Armonk, NY (US); Richard JOHNSON, Palm Beach Gardens, FL (US)

(21) Appl. No.: 17/836,381

(22) Filed: Jun. 9, 2022

Related U.S. Application Data
(63) Continuation-in-part of application No. 17/746,332, filed on May 17, 2022.
Application No. 17/746,332 is a continuation-in-part of application No. 17/452,874, filed on Oct. 29, 2021.

(51) Int. Cl. A61C 8/02

(52) U.S. Cl. CPC A61C 8/0006

(57) ABSTRACT

A novel method for extra-alveolar vertical augmentation utilizing bone graft and low-magnitude high-frequency vibration. Graft material is placed at an extra-alveolar location along the alveolar ridge. The graft can be used alone or formed into a PRF block to help it maintain volumetric shape during the initial healing process. After insertion into the surgical site, the graft can be covered by a barrier, for example a bioactive amnion/chorion barrier. The flaps are then sutured to attempt to obtain primary closure over the graft and barrier. Low-magnitude high-frequency vibration is applied, resulting vertically augmented alveolar bone.

### CROSS-REFERENCE TO RELATED APPLICATIONS

This application is a continuation-in-part of pending commonly assigned U.S. patent application Ser. No. 17/746,332, filed May 17, 2022. This application is also a continuation-in-part of pending of commonly assigned U.S. patent application Ser. No. 17/452,874 filed Oct. 29, 2021. The entireties of each of the above applications are incorporated by reference herein.

### BACKGROUND

### Incorporation by Reference

All publications and patent applications mentioned in this specification are herein incorporated by reference to the same extent as if each individual publication or patent application was specifically and individually indicated to be incorporated by reference.

### Field

The present disclosure relates to periodontal and oral surgery. Aspects of the disclosure describe methods for extra-alveolar augmentation of alveolar bone height. This augmentation can be either following an extraction, to both fill the socket and provide preservation and augmentation of alveolar height, or for providing augmentation outside of the bony envelope. Further aspects of the disclosure concern treatments of periodontal conditions, more specifically, a method to facilitate periodontal treatments and general oral health using mechanical vibration.

### BACKGROUND

Regeneration of degraded periodontal ligament and alveolar bone is the most important goal in periodontal surgical treatments. Frequently, periodontal disease can progress to the stage requiring tooth extraction. In addition, fractured teeth and endodontic failure can both require extraction and can lead to the deterioration of alveolar bone prior to or at the time of tooth removal. Extraction of teeth involves tissue trauma and creates a void in the maxillary or mandibular alveolar bone, which result in remodeling of the extraction site as well as neighboring intact teeth. Neighboring intact teeth can be destabilized by the resorption of adjacent alveolar bone and reformation associated with the extraction of a neighboring tooth. The loss of vertical bone height across the alveolar ridge at a tooth affected by periodontal disease and/or adjacent to a tooth extraction site is known as horizontal bone loss.

Various approaches have been attempted to mitigate supra-alveolar bone loss. The use of grafts to augment the alveolar bone has met with varying degrees of success, but horizontal bone loss has been a particularly difficult challenge. See Jayakumar et al., “Horizontal alveolar bone loss: A periodontal orphan,” J Indian Soc Periodontol. 2010 July-September; 14(3): 181-185.

Grafts to fill the socket left by an extraction have been employed for decades. Schallhorn et al. introduced the use of autogenous hip marrow grafts from the iliac crest during the late 1960's to treat furcation and intrabony defects. See Schallhorn et al., “Iliac transplants in periodontal therapy,” J Periodontol 1970; 41:566-80 and Elsalanty M. E. et al., “Grafts in craniofacial surgery,” Craniomaxillofac Trauma Reconstr 2009; 2:125-34. While gains in crestal bone was reported following the treatment of intrabony defects with hemopoietic marrow grafts, one major problem of using hemopoietic cells is that they contain monoblastic precursors to osteoclasts, cells which resorb bone. The marrow was often so active that resorption of neighboring tooth roots resulted from its use. Additional disadvantages include the added expense, time, the involvement of a secondary surgical site and surgical expertise required for harvesting iliac crest marrow, possibly requiring the involvement of one or more additional surgeons.

The prior art includes reports of dentin grafting for preservation of volume in extraction sockets. Extraction sockets packed with graft material tend to lead to less overall bone loss than an unpacked socket allowed to heal without treatment.

Various approaches using low magnitude high frequency vibration (LMHFV) for enhancing craniofacial bone density or accelerating orthodontic treatments are known.

There is no known application of LMHFV in the prior art for extra-alveolar vertical augmentation of alveolar bone.

### SUMMARY

The present disclosure describes a method for the vertical extra-alveolar augmentation of the height of the alveolar bone. Through the use of LMHFV, reliable extra-alveolar vertical augmentation of alveolar bone is achieved.

According to exemplary embodiments of the disclosure, a method for periodontal and oral surgery includes identifying a location along the alveolar ridge of a patient for dimensional augmentation, opening the gum of a patient at the identified location; packing a graft material comprising dentin onto the alveolar ridge at the identified location; and covering the graft material with a membrane. LMHFV is then applied periodically. Advantageously and surprisingly, extra-alveolar height is augmented.

### BRIEF DESCRIPTION OF DRAWING(S)

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. The patent or application file contains at least one drawing executed in color. Copies of this patent or patent application publication with color drawing(s) will be provide by the Office upon request and payment of the necessary fee. In the drawings:

FIG. 1A depicts an illustrative oral LMHFV device according to one aspect of the disclosure;

FIG. 1B depicts an illustrative oral LMHFV device, such as that depicted in FIG. 1A placed in the mouth of a user, according to one aspect of the disclosure.

FIG. 2 is a preoperative photograph of the dentition of an exemplary patient described in Example 1.

FIG. 3 is a photographic view of the dental arch of the patient described in Example 1 during an exemplary procedure.

FIG. 4 is a photographic view of the dental arch of the patient described in Example 1 at a later stage than FIG. 3 of an exemplary procedure.

FIG. 5 is a photographic view of the dental arch of the patient described in Example 1 showing placement of a barrier.

FIG. 6 is a photographic view of the dental arch of the patient described in Example 1 showing placement of sutures.

FIG. 7 is a follow-up photographic view of the patient described in Example 1 taken five months after the photographic view of FIG. 6.

FIG. 8 is a pre-operative radiographic image of the patient described in Example 1.

FIGS. 9A and 9B are anterior and posterior radiographic images, respectively, of the patient described in Example 2 taken at the time of the photographic image of FIG. 7.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Oral LMHFV Devices

According to an aspect of the present disclosure, an oral LMHFV device that vibrates at one or more predetermined frequencies is provided. In some embodiments the vibrational frequency is fixed within a lower bound and an upper bound. The lower bound can be greater than about 110 Hz, 105 Hz, 100 Hz, 95 Hz, 90 Hz, 85 Hz, 80 Hz, 75 Hz, 70 Hz, 65 Hz, 60 Hz, 55 Hz, 50 Hz, 45 Hz, or less. The upper bound can be greater than about 115 Hz, 120 Hz, 125 Hz, 130 Hz, 135 Hz, 140 Hz, 145 Hz, 150 Hz, or more. In some embodiments, the frequency varies within a lower and an upper bound. In some embodiments two or more frequencies, fixed or varying, are employed.

In some embodiments the duration of a treatment session can be specified to be greater than about 30 seconds, 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, or more; or specified to be less than about 20 min, 19 min, 18 min, 17 min, 16 min, 15 min, 14 min, 13 min, 12 min, 10 min, 9 min, 8 min, 7 min, 6 min, 5 min, 4 min, 3 min, 2 min, 1 min, 30 seconds, or less.

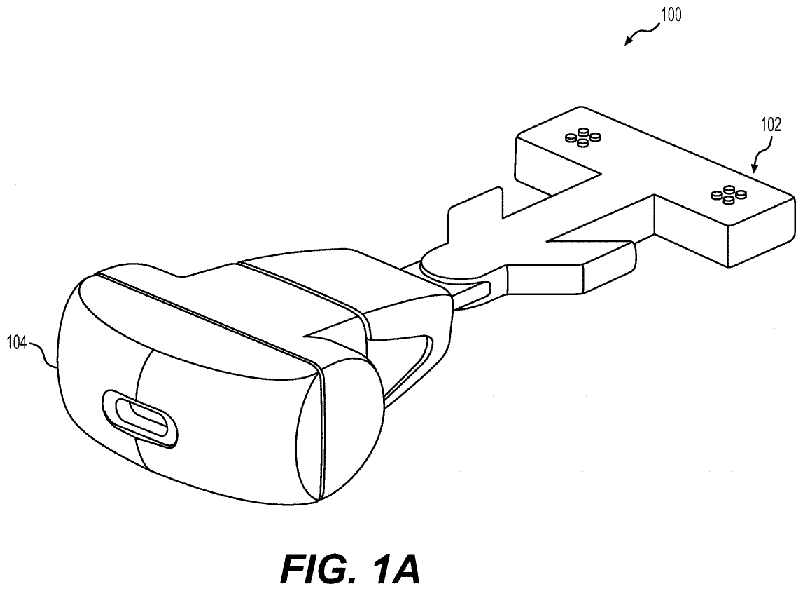

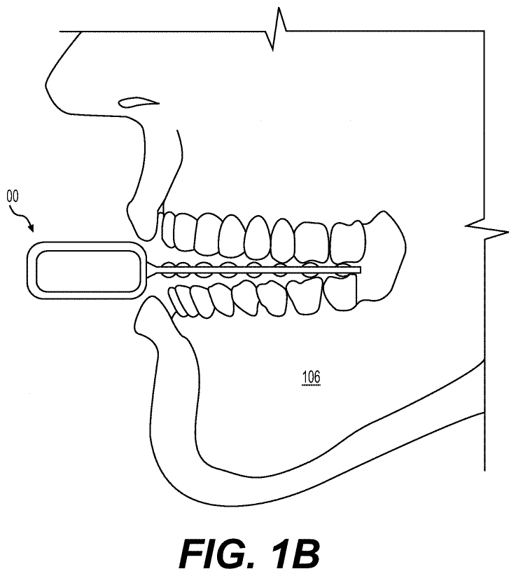

FIG. 1A depicts an oral LMHFV device according to an example. The oral LMHFV device can include a mouthpiece and a vibrational source connected to each other. The mouthpiece is configured to be provided between the occlusal surfaces of a user's teeth, and to be bite down by the user to contact the user's dentition during the treatment. The mouthpiece can cover one or more teeth of the user's dentition to transmit vibrations to the teeth and/or alveolar bone. The vibrational source is configured to provide vibration to the mouthpiece at a preset frequency or range of frequencies and acceleration or range of accelerations.

In an aspect, with reference to FIGS. 1A and 1B, use of the device 100 providing LMHFV to user. Described herein are LMHFV dental devices, which in certain embodiments include a mouthpiece configured to transmit vibration to all or a portion of the patient's teeth. In some embodiments, the appliance can be configured to engage with a patient's teeth alone or can be configured to engage with a patient's teeth and gums. The mouthpiece may gently engage with the gum line at or below the gingival margin to provide stimulation to the soft tissue. Such gentle stimulation can help to increase blood flow and other cells of repair to the site, in addition to that provided by vibration conducted through neighboring teeth and tissue structures. The appliance can be configured to stimulate one or more teeth, the gum line only, or both one or more teeth and the gum line.

Referring to FIGS. 1A-1B, an exemplary dental device 100 includes a mouthpiece 102 operatively connected to a housing 104. The mouthpiece 102 can be separable from the housing 104 for interchangeability between users or for ease of cleaning. The mouthpiece 102 can include one or more oral tissue-contacting portion, such as a biteplate or probe for contacting teeth, gums or other oral tissues. As shown, in FIG. 1A, the mouthpiece can include a biteplate which can be appropriately shaped to cover occlusal surfaces of some or all of a patient's dentition. Other shapes for the mouthpiece are possible. For example, the mouthpiece can be configured to abut the lingual and buccal lateral sides of the alveolar ridge either with or without occlusal contact or, when no teeth are present, contact with gums overlying the alveolar ridge. A vibration generator can be located in the mouthpiece 102 or the housing 104 to vibrate the mouthpiece 102. In some embodiments (not shown) the vibrators can be mounted to the biteplate, and in still further embodiments the entire device can be intraoral. The housing 104 can also include the electronics to run the motor the vibrator, collect usage and device operation data, collect data from sensors in the mouthpiece or base, and store data in memory. The housing 104 can include a data interface which can be wired or wireless to allow a data connection to other devices. The housing 104 can also include a power interface to allow charging of any onboard power sources, such as batteries or capacitor banks. The mouthpiece 102 can be electrically interconnected to the housing 104. FIG. 1B depicts an illustrative dental device 100, such as that described above with reference to FIG. 1A, inserted in the mouth of a human user 106 and engaging the occlusal surfaces of the molars. The mouthpiece of the dental device 100 can, as described above, be sized and shaped to contact any dental tissue, including some or all of the teeth, specific regions of the gums, or both.

As is known in the art, the vibration generator can include an electric motor connected to an eccentric weight, or can be a piezo generator, as well as other known expedients. Accordingly, when the mouthpiece 102 is placed in a patient's mouth and the dental device is 100 turned on, the vibration of the mouthpiece 102 will place vibratory force repetitively on the teeth and/or other oral tissues.

In an example, the patient can be instructed to use the appliance for five minutes daily over a four-month period. The vibration can be applied along multiple axes or selected to be primarily on a single axis. The primary anatomic reference directions with reference to a standing human are superior-inferior (up and down), anterior-posterior (front to back), medial-lateral (side to side). Because mastication places loading on oral structures primarily in the superior-inferior direction through mandibular action, it may be advantageous to choose vibrational loading along other axes either separately or in combination.

To achieve the maximum desired results of alveolar augmentation and optimizing graft material conversion, further studies are still needed to optimize the parameters of LMHFV. Such parameters may include frequency, acceleration, and dosage. Dosage may include duration per use, number of uses per day, or number of days of use, either consecutively or at a certain schedule.

In some embodiments, the vibrational source may be connected to the mouthpiece in such way that the vibration provided is in the sagittal plane of a user's mouth. A motor may be included in the vibrational source to provide such vibration. The motor may be of any suitable type known in the art. The motor, when in use, may be configured to provide vibration at a frequency as disclosed herein. The motor, when in use, may be further configured to provide vibration at an acceleration magnitude. In some embodiments the mouthpiece of a dental vibration device can have an acceleration within a lower bound and an upper bound. The lower bound can be greater than about 0.010 G, 0.015 G, 0.020 G, 0.025 G, 0.030 G, 0.035 G, 0.040 G, 0.045 G, 0.050 G, 0.055 G, 0.060 G, or more; or less than about 0.060 G, 0.055 G, 0.050 G, 0.045 G, 0.040 G, 0.035 G, 0.030 G, 0.025 G, 0.020 G, 0.015 G, 0.010 G, or less. The upper bound can be greater than about 0.07 G, 0.08 G, 0.09 G, 0.10 G, 0.11 G, 0.12 G, 0.13 G, 0.14 G, 0.15 G, or more; or less than about 0.15 G, 0.14 G, 0.13 G, 0.12 G, 0.11 G, 0.10 G, 0.09 G, 0.08 G, 0.07 G, or less.

The motor may be assembled into the vibrational source in an orientation that may provide vibration in the aforementioned ways.

In some embodiments, sensors may be added to the oral LMHFV device, either on the vibrational device, or on the mouthpiece. The sensors may be configured to detect and monitor the parameters of the vibration, for example, frequencies and acceleration magnitudes. The sensors may also be configured to detect if the user has bitten down on the mouthpiece correctly. The sensors may be accelerometers, gyroscopes, proximity sensors, pressure sensors, humidity sensors, temperature sensors, or any combinations of them.

In some embodiments, the mouthpiece could be in contact with at least the teeth or implant proximate to where vertical augmentation is desired. The mouthpiece may be configured to be placed in contact with a user's dentition, between and clamped down by both occlusal surfaces of the dentition. The mouthpiece can include ridges or be without ridges. The mouthpiece can cover the entire dentition, or only a part of the dentition. The shape of the mouthpiece can be customized to cover only selected teeth or implants.

Method for Extra-Alveolar Vertical Augmentation

According to yet another aspect of the present disclosure, a method for extra-alveolar vertical augmentation is described. The method includes providing the mouthpiece of the oral LMHFV device to a user and providing instructions to the user. The instruction may include placement guidelines and dosage information. The dosage information may include duration of each treatment session, number of sessions in a day, number of days, etc. For example, the instruction may instruct a user to use the oral LMHFV device for number of times per day. In some embodiments the treatment frequency can be specified to be once per day, twice per day, 3 times per day, 4 times per day, 5 times per day, 6 times per day, 7 times per day, 8 times per day, 9 times per day, or more. In some embodiments the duration of treatment can be specified to be about 1 day, 1 week, 2 weeks, 3 weeks, 1 month, 2 months, 3 months, 4 months, 5 months, 6 months, 7 months, 8 months, 9 months, 10 months, 11 months, 1 year, or more.

In some embodiments, the method may further include configuring the vibrational source providing an axial vibratory force to the mouthpiece. The axial vibratory force may be eventually applied to the dentition through the mouthpiece, which is clamped down by the teeth. The vibratory force (e.g., acceleration magnitudes, frequencies, etc.) can be adjusted by selecting preset values, or fine-tuned by users, technicians, or healthcare professionals.

According to yet another aspect of the present disclosure, a method for detecting graft material conversion is described. The method includes steps of identifying an extra-alveolar augmentation site, providing a graft material at the augmentation site, applying a stimulus to a portion of the implant site, sensing a baseline response at the implant site, applying one or more vibration sessions over a period of time, sensing at least one second response at the implant site, and determining an augmentation status based on a comparison between the baseline response and one or more second responses. In some embodiments, the method may further include applying a barrier to the graft material. In exemplary embodiments, the graft material can incorporate a growth factor or growth enhancer. Exemplary growth enhancers or facilitators known in the art include calcium sulfate and rhPDGFbb. In an illustrative embodiment, the graft is covered with a barrier and in may further include the step of suturing the barrier and graft material to native tissue at or around the augmentation site.

In some embodiments, the stimulus applied can be one or electrical energy, light energy, and a mechanical dynamic load that is either isotonic or isometric. In addition, the stimulus can be applied to a portion of the augmentation site symmetrically or asymmetrically on one side of the augmentation site or across the augmentation site such as across a facial side and lingual side or mesial side and distal side with respect to any surviving dentition. In some embodiments, sensing a baseline response can include information informing an osseous density at the implant site.

According to exemplary embodiments of the disclosure, a patient is subject to administration of local anesthetic. According to an exemplary embodiment, a previously extracted autologous tooth is then ground and processed using a dental milling apparatus sold under the brand SMART DENTIN GRINDER (available from KometaBio, Fort Lee, N.J.). The tooth is ground into small and large particles. As is generally known in the art, ground autologous dentin contains bioactive materials. In other exemplary embodiments, other graft materials can be used, either alone or in combination and/or mixed autologous ground dentin, such as mineralized cortical and/or cancellous allograft, demineralized freeze-dried allograft and demineralized bone filler. Materials that can be used according to exemplary embodiments include SURGICAL ESTHETICS Mineralized Cancellous allograft (available from Surgical Esthetics Biomedical Technologies, Inc. of Northridge, Calif.), GEM cortical cancellous allograft (available from Lynch Biologics, LLC Franklin, Tenn.), MAXXEUS cancellous allograft (available from Community Tissue Services of Dayton, Ohio), BIO-OSS artificial bone or collagen (available from Edward Geistlich Sohne AG of Lucerne Switzerland); BOND BONE (available from MIS Implants Technologies Ltd. of Bar Lev, Israel) or BOND APATITE (available from Augma Biomaterials Corporation of HaTavor, Israel). Appropriate xenograft materials are also usable, as well as synthetic alloplastic bone substitute material.

According to further aspects of the disclosure, a flap is elevated around the areas where vertical augmentation is desired to expose the alveolar ridge. The surfaces are debrided and cleared of debris. According to still further exemplary aspects of the disclosure, the exposed affected portions can be cleaned with hand and/or ultrasonic and/or piezoelectric instrumentation in preparation for graft placement.

The autologous ground dentin or other graft material can be inserted onto the alveolar treatment area alone, or in an exemplary embodiment in a leucocyte- and platelet-rich fibrin (L-PRF) block to help maintain volumetric shape during the initial healing process. In an illustrative embodiment, ground autologous dentin can be mixed with mineralized allograft if more volume is required. In an exemplary embodiment, the graft mixture is then placed onto the alveolar bone at the level of the ideal alveolar crest or cementoenamel junction (CEJ). Next, a barrier is placed around and over the grafted area and tucked under the flap margins. In an illustrative embodiment of the disclosure, a dehydrated human deepithelialized amnion-chorion membrane sold under the trade name BIOXCLUDE (available from Snoasis Medical, Golden, Colo.) serves as a barrier. The flaps are then sutured in an attempt to obtain primary closure over the graft and barrier. In an exemplary embodiment, although primary closure is not required, sutures are placed to secure the soft tissue flaps in place. Other barriers according to additional exemplary embodiments include pericardium, CYTOPLAST membranes (available from Osteogenics Biomedical, Inc. of Lubbock, Tex.), GEM Adapt (available from Lynch Biologics, LLC Franklin, Tenn.), MATRIXDERM, MATRIXDERM Extend (available from Collagen Matrix, Inc. of Oakland, N.J.), MATRIX FLEX Regenerative Collagen Dental Membrane (available from Sabra Dental Products of Deer Park, N.Y.), BIOMEND collagen membrane (available from Colla-Tec, Inc. of Plainsboro N.J.), COPIOS (available from Zimmer Spine Inc. of Minneapolis Minn.), TUTOPATCH (available from RTI Surgical of Alachua, Fla.), and OSSIX barrier membranes (available from Datum Biotech Ltd. of Ness Ziona, Israel).

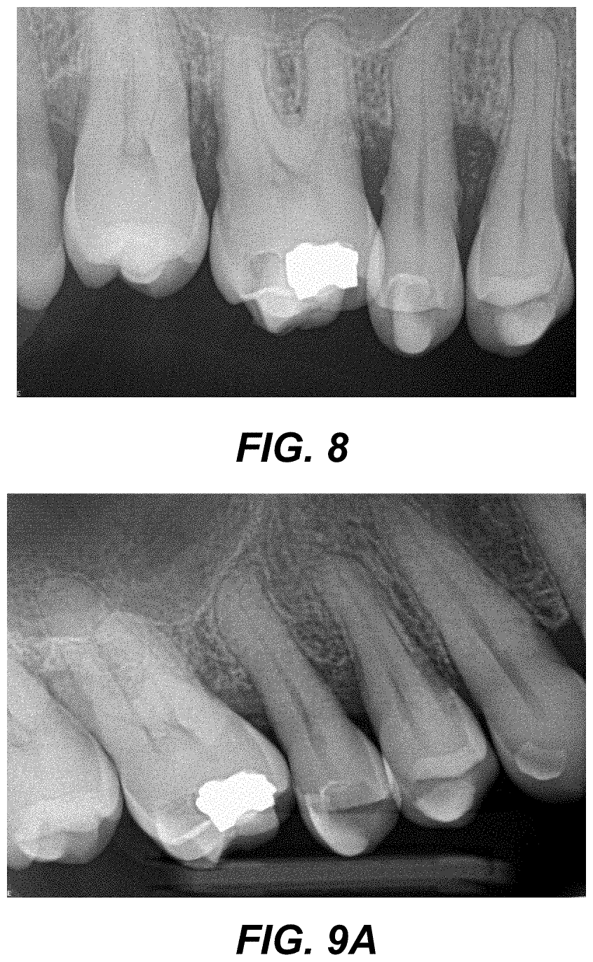

A periapical radiograph can be taken to document the level of graft placement. An exemplary patient radiograph discussed in Example 1 appears as FIG. 8.

Over time, the barrier becomes absorbed into the soft tissues. The autogenous dentin or other graft material recruits endothelial and osteoblast cells. Over time the graft completely blends with the surrounding host bone and no differentiation is be noted between the native bone and previously placed graft radiologically. Initially, Type I macrophages (M1) are present; and over time owing to the growth factors present in dentin, modulation to Type II macrophages (M2), changing their activity from resorption to bone regeneration. See Nasizrade et al., “Acid Dentin Lysate Modulates Macrophage Polarization and Osteoclastogenesis In Vitro,” Materials 2021, 14, 6920.

The patient can be instructed to bite gently on an LMHFV device for 5 minutes daily starting on the day of the surgical procedure. The patient can continue to use the device until the bone has fully matured, after approximately 4 to 9 or more months. If a dental implant is placed in the treated site, the patient will continue to use the vibration device until the implant is prosthetically loaded with a crown or other restoration. Typically, in this instance, the treatment time can be anywhere from about 3 months to about 6 to 9 months or more. In an exemplary embodiment, periodontal probing can be performed within 4-6 months.

Advantageously, extra-alveolar vertical bone growth is achieved. To Applicant's knowledge, this has not been achievable predictably in the prior art. Restoring or augmenting the alveolar bone as described herein can promote better oral health, stop resorption, and provide a renovated, stable location for dental implants.

### Example

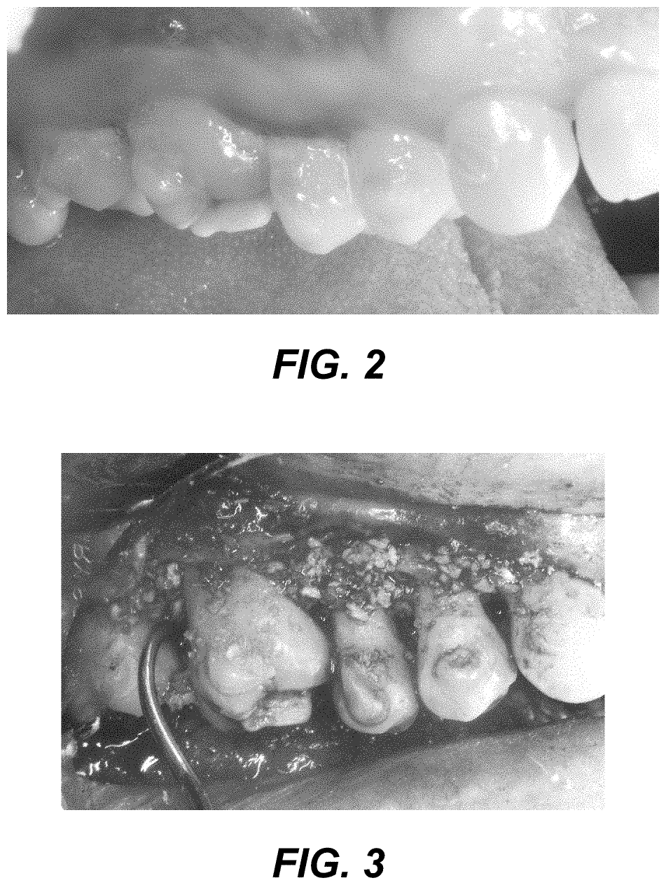

FIG. 2 is a photograph taken from a patient presenting with severe periodontal disease threatening four intact teeth. An extraction was performed at a location not adjacent to the four at-risk teeth. A resorption of the alveolar ridge is evident from the image, as well as gum recession. A pre-operative radiograph was taken as shown in FIG. 8.

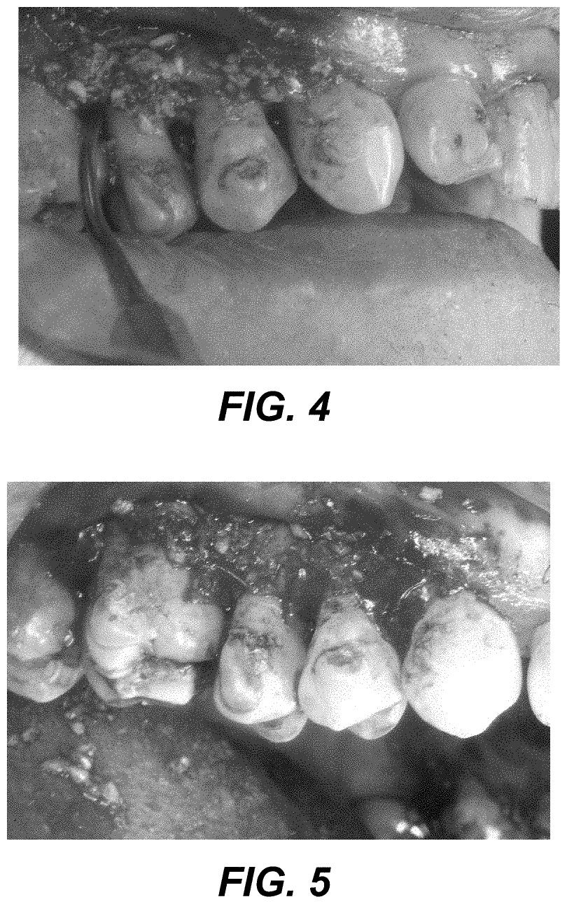

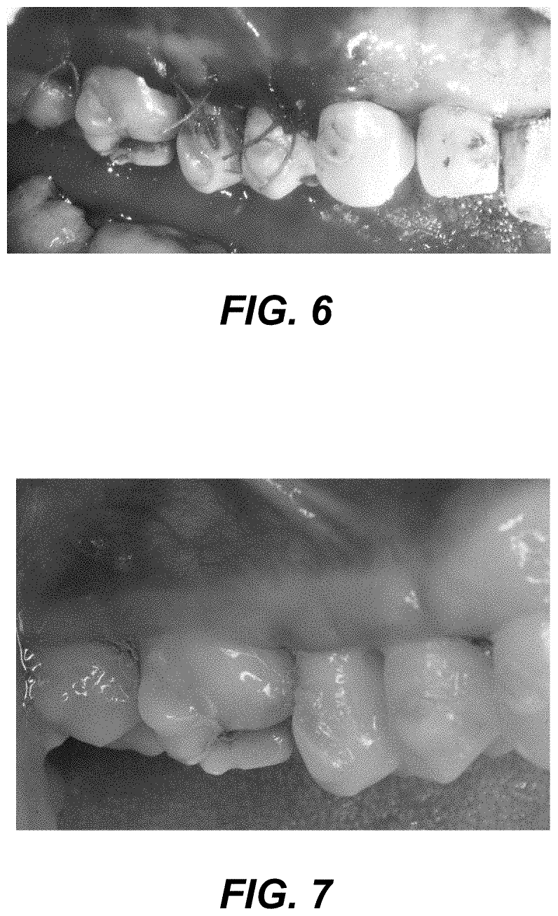

As shown in FIG. 3, a flap was created to expose the roots of the compromised teeth. As described herein, autologous dentin was made into an L-PRF block and packed around the compromised roots to stabilize the at-risk teeth. Additional space was made, as shown in FIG. 4, to accommodate placement of a barrier as described above and shown in FIG. 5. Sutures were used to secure the barrier and provide closure of the flaps as shown in FIG. 6.

The patient was instructed to bite gently on an LMHFV device (PerioTech LLC) for 5 minutes daily starting on the day of the surgical procedure. The patient continued to use the device until the bone was fully matured after approximately 5 months, as confirmed by probing.

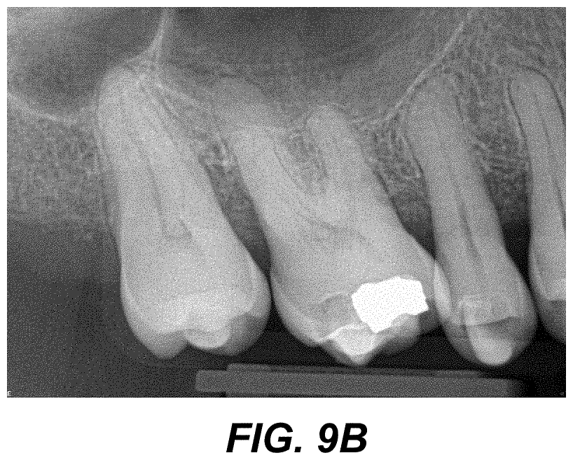

Follow-up images were taken at 5 months and appear as the photograph of FIG. 8 and the radiographs of FIGS. 9A and 9B. The radiograph of FIG. 9A shows an anterior view and the radiograph of FIG. 9B shows a posterior view. These images show excellent augmentation and stabilization of the graft. Follow up exams confirmed resolution of periodontal disease and excellent prognosis. Augmentation of the alveolar ridge is clearly visible in FIGS. 9A and 9B as compared to pre-operative radiograph FIG. 8. Augmentation was measured to be 4-5 mm in the vertical dimension.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for oral surgery, comprising:
identifying a first location along the alveolar ridge of a patient for dimensional augmentation,
opening the gum of a patient at the first location;
packing a graft material comprising dentin onto the alveolar ridge and the first location;
covering the graft material with a membrane;
applying low magnitude high frequency vibration orally;
wherein alveolar height is augmented vertically.

2. The method of claim 1, wherein the graft material comprises one or more of autologous dentin, mineralized or demineralized allograft or xenograft or a synthetic alloplastic bone substitute material.

3. The method of claim 2, further comprising the step of grinding one or more autologous teeth.

4. The method of claim 1, wherein the second location is at a defect or extraction socket.

5. The method of claim 1, wherein the step of opening the gum includes forming a periodontal flap.

6. The method of claim 1, wherein the step of opening the gum includes performing a sub-periosteal tunnel procedure.

7. The method of claim 1, wherein the step of opening the gum includes extracting a tooth.

8. The method of claim 1, wherein the membrane in the covering step is amnion-chorion membrane.

9. The method of claim 1, wherein the graft comprises L-PRF block.

10. The method of claim 1, wherein the graft comprises a growth enhancer.

11. A method for vertically augmenting alveolar bone lateral to a treatment site, comprising:
identifying a location along the alveolar ridge of a patient for dimensional augmentation,
packing a graft material at the first location; and
applying low magnitude high frequency vibration orally;
wherein
alveolar height is preserved or augmented at the first location.

12. The method of claim 11, wherein the graft material comprises autologous dentin.

13. The method of claim 12, further comprising the step of grinding one or more autologous teeth.

14. The method of claim 11, further comprising the step of forming a periodontal flap.

15. The method of claim 11, further comprising the step of covering the graft material with a membrane.

16. The method of claim 15, wherein the membrane in the covering step is amnion-chorion membrane.

17. The method of claim 11, wherein the graft comprises L-PRF block.

18. The method of claim 11, wherein the graft comprises a growth enhancer.

19. The method of claim 11, wherein alveolar height is preserved or augmented at the first location.
